(19) United States
(12) Patent Application Publication
(10) Pub. No.: US 2026/0307372 A1
(43) Pub. Date: Oct. 8, 2026

(54) LEATHER-LIKE STRUCTURE

(71) Applicant: RAETHER SOCIETA’ A RESPONSABILITA’ LIMITATA, Torino (IT) (IT)

(72) Inventor: Marco FOGLIZZO, Torino (IT) (IT)

(73) Assignee: RAETHER SOCIETA’ A RESPONSABILITA’ LIMITATA, Torino (IT) (IT)

(21) Appl. No.: 19/481,857

(22) PCT Filed: May 7, 2024
(86) PCT No.: PCT/IB2024/054427

§ 371 Date: Nov. 5, 2025

(30) Foreign Application Priority Data
May 8, 2023 (IT) 102023000009111

(51) Int. Cl. B32B 27/12; B32B 5/02; B32B 27/30; B32B 27/40

(52) U.S. Cl. CPC B32B 27/12; B32B 5/02; B32B 27/304; B32B 27/40; B32B 2262/0276; B32B 2262/08; B32B 2307/7376

(57) ABSTRACT

A leather-like structure comprising a support substrate comprising two semi-finished substrates, which comprise polyester fiber and leather fiber; the two semi-finished substrates are fixedly connected to each other on two respective mating surfaces and define two outer surfaces of the support substrate; the mating surfaces comprise a polyester fiber concentration greater than the outer surfaces. The leather-like structure further comprises a surface substrate arranged on one of the outer surfaces.

### CROSS-REFERENCE TO RELATED APPLICATIONS

This Patent Application claims priority from Italian Patent Application No. 102023000009111 filed on May 8, 2023, the entire disclosure of which is incorporated herein by reference.

### TECHNICAL FIELD

The present invention relates to a leather-like structure.

The present invention is preferably, although not exclusively, applied to the field of clothing, footwear, leather goods, and decoration of vehicles such as yachts, private planes or cars. In the following, reference will be made to such application by way of example.

### STATE OF THE PRIOR ART

Leather derived from animal skin (called natural leather or leather) is frequently employed for the manufacturing, for example, of garments, shoes, accessories as well as for the interior decoration of luxury vehicles such as yachts, private planes or high-end cars.

Natural leather products are unanimously appreciated, despite sometimes being high in price, for their tactile sensation, so-called texture, their appearance and durability, characteristics which are obtained by subjecting the rawhide to numerous processes such as cleaning, tanning, finishing, and conservation.

It is known that the processing of rawhides into leather represents an upcycling of a by-product of the food industry: for over 99% of cases, rawhide derives from animals (cattle, sheep, goats, pigs) which are farmed for the purpose of producing food, such as meat and milk.

However, the machining processes to which the rawhide is subjected (particularly the tanning process) involve a high consumption of water and use of chemicals, two important aspects to take into account due to their significant environmental impact.

The growing awareness for environmental and ethical issues (e.g. animal rights), as well as the occasionally high prices of natural leather, have led to the appearance on the market of materials alternative to natural leather, among which imitation leather.

Imitation leather, also known as faux leather, eco-leather, or ecological leather, is a product traditionally obtained by spreading polyurethane-based (PU) and polyvinyl chloride-based (PVC) products onto bases of various kinds, among which fabric or microfibers. The quality and characteristics of these products are governed by standard UNI 11427:2022.

According to known solutions, a leather-like structure is produced from a semi-finished substrate, onto which polyurethane-based (PU) and polyvinyl chloride-based (PVC) products, often admixed with adhesives or silicones, are spread. According to other known solutions, multiple semi-finished substrates are overlaid and glued to then be spread. After the spreading, a finishing process is performed, if necessary, to impart particular colors or textures to the structure.

Document U.S. Pat. No. 3,537,871A describes a leather-like structure composed of a non-woven base fabric made of a mixture of collagen fibers and natural or synthetic fibers, and a coating film of amino acid resin which adheres to the base fabric by means of an intermediate layer of resin binder.

Document CN109353088A describes a regenerated leather base fabric manufactured by the wet laying-up of multi-layer and multi-mesh collagen fibers and a relative manufacturing method.

Document WO2022219484A1 describes a method for the dry manufacturing of a non-woven fabric from tanned leather waste.

Document CN114561746B describes a method for manufacturing an animal fiber composite full-layer leather.

Generally, the aesthetic performance of the materials manufactured by means of these techniques is modest, as well as their wear resistance. Furthermore, their price is significantly lower than that of natural leather, making them particularly competitive on the market.

However, the breathability of these materials results to be very poor and their appearance very far from that of natural leather. Furthermore, for their manufacturing, particularly polluting plastics (such as PU and PVC) are used, which considerably depart from the environmental sustainability goals.

In view of the foregoing, the need is felt to create a material alternative to leather which has an aesthetic appearance, performance, texture, breathability, and workability as close as possible to those of natural leather and, at the same time, has an environmental impact lower than natural leather and the other known solutions mentioned above, and, in general, as low as possible.

Furthermore, the need is felt to create a material which does not contain adhesives or silicones as aggregants or anchoring structures such as meshes, and which is mainly composed of available (recycled) and non-virgin materials, and which is finally recyclable.

The object of the present invention is to meet the needs set forth above in an optimized and cost-effective manner.

### SUMMARY OF THE INVENTION

The aforementioned object is obtained thanks to a leather-like structure as claimed in the appended claims.

### BRIEF DESCRIPTION OF THE DRAWINGS

In order to better understand the present invention, a preferred embodiment is described in the following, by way of non-limiting example and with reference to the accompanying drawings wherein:

FIG. 1 is a schematic section view of a leather-like structure according to the present invention; and

FIG. 2 is a schematic section view of a portion of the leather-like structure of FIG. 1.

### DETAILED DESCRIPTION OF THE INVENTION

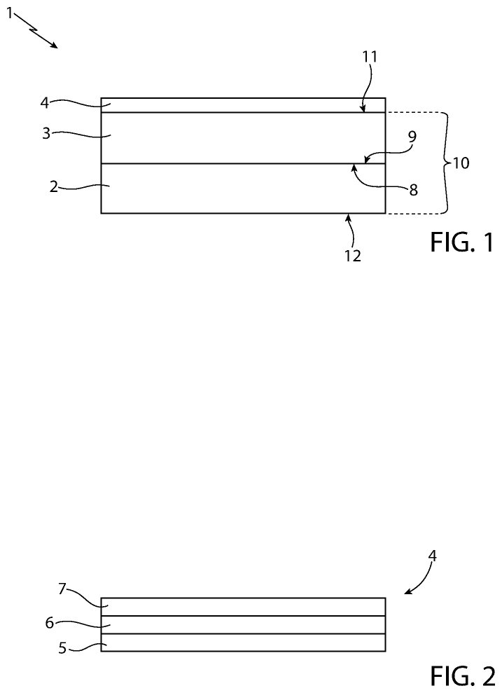

In FIG. 1, a leather-like structure according to the invention for the manufacturing of leather goods, for example, interior decoration for vehicles or garments, is shown as a whole by reference numeral 1.

In the illustrated embodiment, the leather-like structure 1 is a multilayer sheet, i.e. having a thickness and a width, visible in the section of FIG. 1, and a length, in the normal direction to the section plane, where the thickness is much less than length and width, e.g. at least by an order of magnitude.

The leather-like structure 1 comprises a support substrate 10 comprising two semi-finished substrates 2, 3 each comprising polyester fiber and leather fiber.

In particular, the semi-finished substrates 2, 3 are essentially composed of complementary weight percentages of polyester fiber and leather fiber, i.e. do not contain further elements such as binders and/or aggregants (silicones, resins, etc.) or anchoring structures such as meshes. In other words, the semi-finished substrates 2, 3 only contain polyester fiber and leather fiber.

Considering the total weight of a semi-finished substrate, the weight percentage of polyester fibers is calculated from the ratio between the weight of polyester fibers and the total weight.

According to a preferred embodiment, the polyester fibers used for the manufacturing of the semi-finished substrates 2, 3 come from, at least in part, recycled materials; in particular, polyester fibers are derived for about 50% in total from recycled PET, for example from PET bottles or from industrial polyester or clothing waste.

The leather fibers used for the manufacturing of the semi-finished substrates 2, 3 usually come from the natural leather processing waste.

The manufacturing process of semi-finished substrates (known per se and therefore not described in detail in the following) allows obtaining a semi-finished substrate containing weight percentages of leather fibers and polyester fibers in varying proportions.

The two semi-finished substrates 2, 3 are fixedly connected to each other on two respective mating surfaces 8, 9 and define two outer surfaces 11, 12 of the support substrate 10.

Following the manufacturing process, within a semi-finished substrate, the composition of leather fiber and polyester fiber results to be non-uniform in the direction of its thickness. In other words, the weight percentage of polyester fibers and leather fibers varies within the semi-finished substrate from a surface with a minimum weight percentage of polyester fiber to an opposite surface with a maximum weight percentage of polyester fiber.

In detail, the preferential mating surfaces 8, 9 comprise a weight percentage of polyester fiber greater, i.e. a maximum percentage, than the outer surfaces 11, 12, i. e. a minimum percentage. Consequently, the outer surfaces 11, 12 have a weight percentage of leather fiber higher, i. e. a maximum percentage, than the mating surfaces 8, 9, i. e. a minimum percentage.

Therefore, the two semi-finished substrates 2, 3 are connected to each other by mating the surfaces 8, 9 with higher concentration of polyester fiber.

Advantageously, the leather-like structure 1 comprises a surface substrate 4 arranged on one of the outer surfaces 11, 12 of the support substrate 10. According to the illustrated non-limiting embodiment, the surface substrate 4 is arranged on the outer surface 11. In particular, the surface substrate 4 entirely covers the outer surface 11.

Preferably, the semi-finished substrate 2; 3 comprises a weight percentage of leather fiber greater than or equal to 60% and a weight percentage of polyester fiber less than or equal to 40%.

In particular, the semi-finished substrate 2, 3 comprises a weight percentage of leather fiber greater than or equal to 80% and a weight percentage of polyester fiber less than or equal to 20%.

According to a preferred embodiment, the weight percentage of leather fiber of both semi-finished substrates 2, 3 is equal to 85%, and the weight percentage of polyester fiber is equal to 15%.

Preferably, the support substrate 10 comprises a thickness greater than or equal to 0.4 mm and less than or equal to 2.8 mm. In particular, the support substrate 10 comprises a thickness greater than or equal to 0.6 mm and less than or equal to 2.6 mm. Such thicknesses are compliant with the thicknesses required by the typical tanning industry processing; in particular, the mentioned thickness values are compatible with the further addition of a surface layer 4.

According to a preferred embodiment, the support substrate 10 has a thickness of 1.5 mm; in particular, each semi-finished substrate 2, 3 has a thickness equal to half the total thickness of the support substrate 10, i.e. 0.75 mm. According to other embodiments not illustrated, the semi-finished substrates 2, 3 have different thicknesses from each other.

Preferably, as is visible in FIG. 2, the surface substrate 4 comprises a primer substrate 5 arranged in contact with the outer surface 11, a finishing substrate 6 arranged on the primer substrate 5, and a fixative substrate 7 arranged on the finishing substrate 6.

Advantageously, the primer substrate 5 comprises varying weight percentages of acrylic resins, polyurethane resins, and synthetic or natural caseins and waxes.

Preferably, the primer substrate 5 also comprises varying weight percentages of covering materials. In particular, the covering materials can be matting substances and covering fillers.

In particular, the primer substrate 5 is directly applied to the outer surface 11 to adjust and activate it so as to favor the anchoring of the following substrate.

Advantageously, the finishing substrate 6 comprises varying percentages of acrylic resins, polyurethane resins, and (synthetic or natural) caseins and waxes.

Preferably, the finishing substrate 6 also comprises varying weight percentages of covering materials. In particular, the covering materials can be matting substances.

In particular, the finishing substrate 6 substantially consists of a varnish layer or other layer or film which provides the desired coloring to the leather-like structure 2.

Advantageously, also the fixative substrate 7 comprises varying percentages of acrylic resins, polyurethane resins, and (synthetic or natural) caseins and waxes.

Preferably, the fixative substrate 7 also comprises varying weight percentages of covering materials. In particular, the covering materials can be matting substances.

In detail, the fixative substrate 7 is configured to block the finishing substrate 6, in particular, thanks to catalysts within its composition, and “fixes” the color with respect to abrasions or scratches.

Preferably, both the primer substrate 5 and the finishing substrate 6 as well as the fixative substrate 7 comprise varying weight percentages of covering materials.

According to a possible embodiment, the surface substrate 4 comprises polyurethane and/or polyvinyl chloride. Although not in line with eco-friendly goals, these compounds can be applied by using spreading processes in place of or in addition to the surface substrate 4 in the event particular performance techniques of the leather-like structure 1 are required with respect to, for example, waterproofing.

The invention also relates to a method for manufacturing a leather-like structure 1 as described above. The method comprises the steps of:
arranging a first semi-finished substrate 3 on a second semi-finished substrate 2, so that respective surfaces 8, 9 with higher weight percentage of polyester fiber of each of the semi-finished substrates 3, 2 are in contact with each other;
fixedly connecting the first semi-finished substrate 3 and the second semi-finished substrate 2 to obtain a support substrate 10; and
coating an outer surface 11 of the support substrate 10 with a surface substrate 4.

Preferably, the step of fixedly connecting the semi-finished substrates 3, 2 is performed by the waterjet technique. In particular, during this step, no petrochemical binders or adhesives are added.

Preferably, the step of coating with the surface substrate 4 comprises in turn the subsequent steps of:
applying a primer substrate 5;
applying a finishing substrate 6; and
applying a fixative substrate 7.

In view of the foregoing, the advantages of the leather-like structure 1 according to the invention are apparent.

Thanks to the advantageous arrangement of the semi-finished substrates 2, 3 described above, the outer surfaces 11, 12 of the support substrate 10 contain a higher weight percentage of leather fiber, which determines the characteristics of the structure 1 in terms of aesthetics and function. In fact, thanks to the high weight percentage of leather fibers, these characteristics are close to those of a natural leather structure, i.e. leather directly derived from animal skin.

Furthermore, the presence of the surface substrate 4 allows improving the surface characteristics of the leather-like structure 1 in terms of both appearance and texture as well as technical performance.

In particular, by applying the surface substrate 4 to the outer surface 11 of the support substrate 10, the leather-like structure 1 obtains an appearance which is identical and a breathability which is similar to those of natural leather.

Therefore, the proposed leather-like structure 1 and the proposed manufacturing method of said leather-like structure 1 allow obtaining a material alternative to natural leather which has aesthetic appearance, performance, texture, breathability and workability close to those of natural leather.

Furthermore, the proposed leather-like structure 1 and the proposed manufacturing method of said structure allow obtaining a material which has a much lower, and generally the lowest possible, environmental impact than natural leather and the other known solutions.

In detail, the proposed leather-like structure 1 does not contain any adhesives or silicones as aggregants, or any anchoring structures such as meshes, and it is mainly composed of available (recycled) and non-virgin materials, and it is recyclable.

It is evident that modifications may be made to the leather-like structure 1 and to the relative production method described, which do not go beyond the scope of protection defined by the claims.

For example, the width and the thickness of the structure 1 may vary as well as its shape and/or the composition of the semi-finished substrates 2, 3.

In addition, the appearance of the surface substrate 4 as well as its arrangement may vary. For example, the surface layer 4 may be arranged on the outer surface 12. More generally, the surface layer 4 may cover even only partially the outer surface 11; 12.

In detail, the leather-like structure 1 may have different coloring and/or surface processing, perforations and/or thickness reductions, as long as it comprises the claimed operating characteristics.

1. A leather-like structure comprising:
a support substrate comprising two semi-finished substrates, each of said semi-finished substrates comprising polyester fiber and leather fiber, the two semi-finished substrates being fixedly connected to each other on two respective mating surfaces, thereby defining two outer surfaces of said support substrate ; and
a surface substrate arranged on one of said outer surfaces;
said mating surfaces comprising a weight percentage of polyester fiber greater than said outer surfaces.

2. The leather-like structure according to claim 1, wherein said semi-finished substrates comprise a weight percentage of leather fiber greater than or equal to 60% and comprise a weight percentage of polyester fiber less than or equal to 40%.

3. The leather-like structure according to claim 1, wherein said semi-finished substrates comprise a weight percentage of leather fiber greater than or equal to 80% and comprise a weight percentage of polyester fiber less than or equal to 20%.

4. The leather-like structure according to claim 1, wherein said support substrate comprises a thickness greater than or equal to 0.4 mm and less than or equal to 2.8 mm.

5. The leather-like structure according to claim 1, wherein said support substrate comprises a thickness greater than or equal to 0.6 mm and less than or equal to 2.6 mm.

6. The leather-like structure according to claim 1, wherein said surface substrate comprises polyurethane and/or polyvinyl chloride.

7. The leather-like structure according to claim 1, wherein said surface substrate comprises:
a primer substrate arranged in contact with said outer surface;
a finishing substrate arranged on said primer substrate; and
a fixative substrate arranged on said finishing substrate.

8. The leather-like structure according to claim 7, wherein the primer substrate comprises varying weight percentages of acrylic resins, polyurethane resins, and synthetic or natural caseins and waxes.

9. The leather-like structure according to claim 7, wherein the finishing substrate comprises varying weight percentages of acrylic resins, polyurethane resins, and synthetic or natural caseins and waxes.

10. The leather-like structure according to claim 7 wherein the fixative substrate comprises varying weight percentages of acrylic resins, polyurethane resins, and synthetic or natural caseins and waxes.

11. The leather-like structure according to claim 7, wherein the primer substrate (5) and/or the finishing substrate and/or the fixative substrate comprise varying weight percentages of covering materials.

12. A production method for a leather-like structure comprising the steps of:
arranging a first semi-finished substrate on a second semi-finished substrate, so that respective surfaces with higher weight percentage of polyester fiber of each of said semi-finished substrates are in contact with each other;
fixedly connecting said first semi-finished substrate and said second semi-finished substrate to obtain a support substrate; and
coating an outer surface of said support substrate with a surface substrate.

13. The method according to claim 12, wherein the step of fixedly connecting said semi-finished substrates is performed by the waterjet technique.

14. The method according to claim 12, wherein the step of coating with said surface substrate comprises the subsequent steps of:
applying a primer substrate;
applying a finishing substrate and applying a fixative substrate.
